(19) United States
(12) Patent Application Publication
(10) Pub. No.: US 2023/0012244 A1
(43) Pub. Date: Jan. 12, 2023

(54) EDUCTOR SENSOR SYSTEM

(71) Applicants: JOHN M. PETERMAN, TROY, MO (US); MARK A. ROBERTS, ST. CHARLES, MO (US)

(72) Inventors: JOHN M. PETERMAN, TROY, MO (US); MARK A. ROBERTS, ST. CHARLES, MO (US)

(73) Assignee: GPRE IP, LLC, St. Louis, MO (US)

(21) Appl. No.: 17/803,169

(22) Filed: Jun. 9, 2021

Related U.S. Application Data
(60) Provisional application No. 63/037,319, filed on Jun. 10, 2020.

(51) Int. Cl. F24F 11/74

(52) U.S. Cl. CPC F24F 11/74; F24F 2110/50

(57) ABSTRACT

An automatic variable speed eductor recirculation system for metal recycling furnaces having a delacquering chamber and a separate heating chamber. The system includes a recirculation duct between the two chambers, an eductor in the duct, a variable speed blower forcing motive gases into the eductor creating a Venturi that draws VOC's from the delacquering chamber through the eductor, and an infrared opacity sensor proximate the eductor that measures the transparency level of the gases in the eductor. An electronic controller automatically adjusts the blower speed to control the eductor Venturi based upon the transparency level measurements of the opacity sensor.

### CROSS REFERENCE TO RELATED APPLICATIONS

This application derives and claims priority from U.S. provisional application 63/037,319 filed 10 Jun. 2020, and having Attorney Docket No. GILP F584US (17404 00011), which application is incorporated herein by reference.

### Statement Regarding Federally Sponsored Research or Development

Not applicable.

### BACKGROUND OF THE INVENTION

This invention relates principally to a detection system to control gas flow through a gas recirculation system for a metal furnace or kiln, and more particularly to an infrared opacity sensing system for a coated scrap melting furnace that identifies the opacity level in an eductor recirculation system caused by the organic and particulate VOC's off-gassing from coated metal scrap in the delacquering chamber of the furnace, and simultaneously controls the operation of the eductor based upon such opacity levels.

It has for some time been a standard practice to recycle scrap metals, and in particular scrap aluminum. Various furnace and kiln systems exist that are designed to recycle and recover aluminum from various sources of scrap, such as used beverage cans (“UBC”), siding, windows and door frames, etc. One of the first steps in these processes is to use a rotary kiln to remove the paints, oils, and other surface materials (i.e., volatile organic compounds or “VOC's”) on the coated scrap aluminum (i.e. “feed material”). This is commonly known in the industry as “delacquering.” Delacquering is typically performed in an atmosphere with reduced Oxygen levels and with temperatures in excess of 900 degrees Fahrenheit. However, the temperature range at which the paints and oils and other surface materials are released from the aluminum scrap in the form of unburned volatile gases typically ranges between 450 and 600 degrees Fahrenheit, which is generally known as the “volatilization point” or “VOL.” The delaquering chamber may be run as hot as 900 degrees Fahrenheit to ensure that sufficient heat is transferred throughout the scrap load to achieve an internal temperature of at least 450 degrees Fahrenheit.

In various such metal recycling systems, the furnace comprises multiple compartments or chambers to accommodate serial steps in the recycle process. For example, for aluminum scrap that is coated with paints and various other surface materials, it is typical to remove such coatings from the scrap aluminum before the aluminum is actually melted. Thus, in a simplistic model, such an aluminum recycle system will require at least two chambers—one for delacquering and one for actual melt purposes. Moreover, it has been recognized that VOC's outgassed or delacquered from the scrap metal can be recaptured in gaseous form and used as a burn fuel to thereafter help melt the scrap metal in the melt chamber. Traditional aluminum delacquering-melt furnaces that seek to utilize outgassed VOC's for fuel simply collect and route the VOC's from the interior of the scrap metal delacquering chamber and funnel them into the melt chamber using a complicated system of electric fans and valves, which includes various electric fans positioned in air ducts that extend from the delaquering chamber to the melt chamber.

One improvement to the traditional approach, as disclosed in a contemporaneously filed U.S. provisional patent application filed by Applicants, is to utilize an eductor system to collect the VOC's from the delacquering chamber with an eductor and re-route them into the melt chamber. This system operates in a continuous gas flow manner through the eductor. However, it has been found that greater efficiency can be achieved in the eductor system by regulating the rate of gas flow through the eductor, depending on the volume of VOC's in the delacquering chamber of the furnace. It would therefore be desirable to have an apparatus or system for an eductor driven gas recycle system of an aluminum melt furnace that properly adjusts the eductor gas flow to improve the efficiency of the system. As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a perspective cross-sectional view of a scrap aluminum melt furnace with a delacquering chamber incorporating one embodiment of the present invention;

FIG. 2 is a partially diagrammatic cross-sectional plan view of the scrap aluminum melt furnace of FIG. 1;

FIG. 3 is a top view of the scrap aluminum melt furnace of FIG. 1;

FIG. 4 is an alternate top front perspective view of the front end of the scrap aluminum melt furnace of FIG. 1;

FIG. 5 is an alternate top rear perspective view of the center and back end of the scrap aluminum melt furnace of FIG. 1, showing the eductor systems on top of the furnace;

FIG. 6 is a partially diagrammatic enlargement of the upper central portion of FIG. 2;

FIG. 7 is a schematic computer system flow chart of the computer control system for the furnace of the present disclosure in association with various system control loops.

Corresponding reference characters indicate corresponding parts throughout the several views of the drawings.

### DETAILED DESCRIPTION

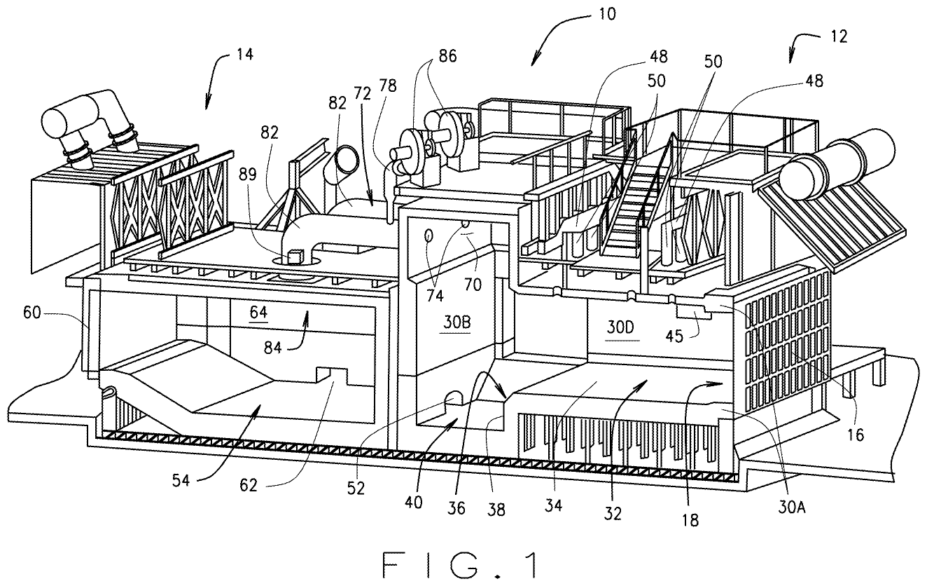

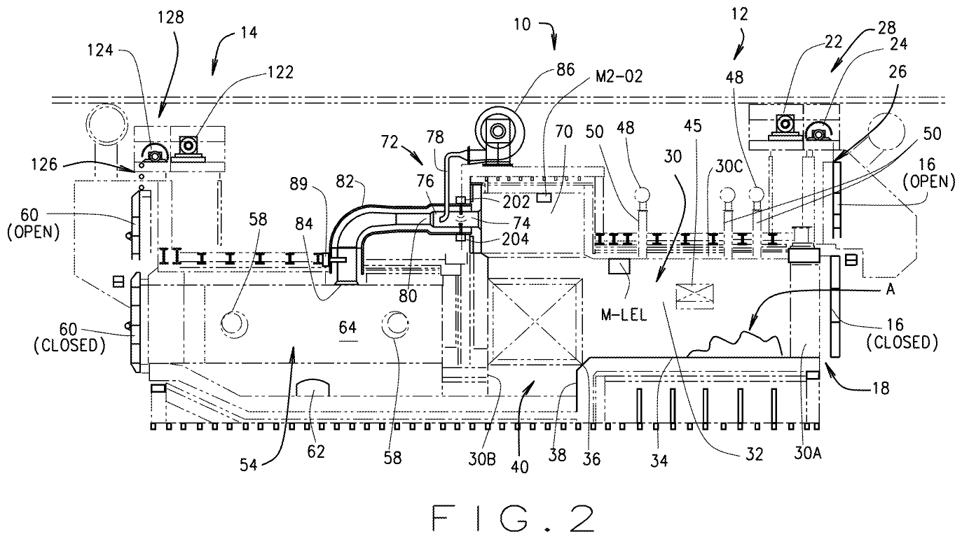

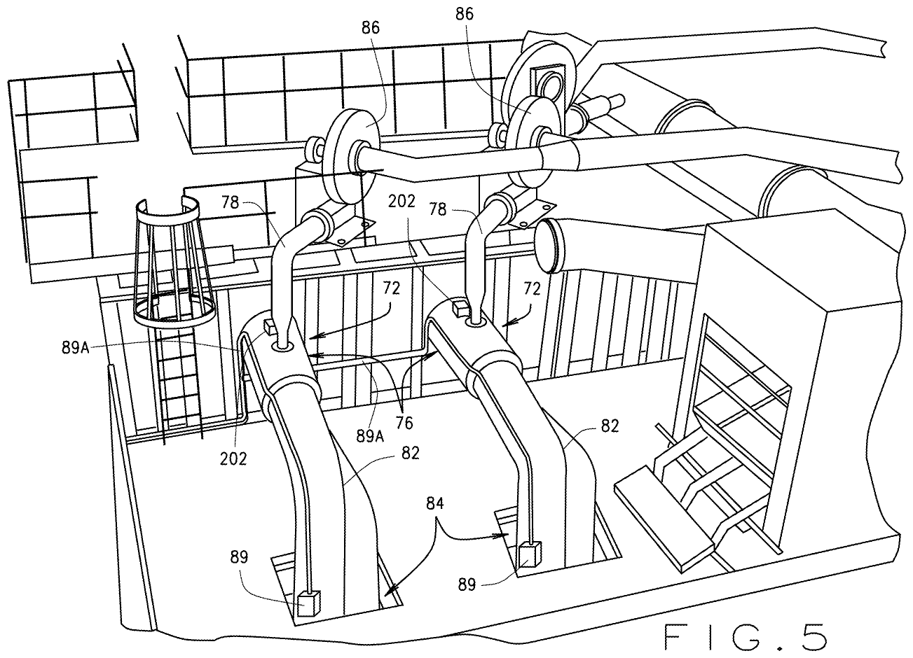

In referring to the drawings, an embodiment of a representative scrap aluminum delacquering and melt furnace 10 is shown generally in FIGS. 1-5, where the novel VOC's capture eductor system 72 of the present invention is depicted by way of example as integrated into the furnace 10. As can be seen, the furnace 10 has a front end 12 and a back end 14 opposite the front end 12. A vertical, rectangular steel gate or door 16 is positioned, when closed, against a doorway 18 in the front end 12 of the furnace 10. The door 16 is approximately twenty-two feet wide and ten feet tall, and one foot thick. An electric lift motor 22 and associated lift gears 24, are positioned above the door 16 atop the front end of the furnace 10. A set of heavy chains 26 attach at one end to the door 16 and attach at the other end to the lift gears 24. The motor 22, lift gears 24 and chains 26 collectively form an opening system 28 for the door 16. A computer control system CCS for the furnace 10 operatively communicates with the opening system 28 to controllably raise and lower the door 16 between its closed position (as depicted in FIG. 1 and denoted in FIG. 2 as “CLOSED”), in which the door 16 rests against and seals the doorway 18, and its open position in which the door 16 fully exposes the doorway 18 (as depicted and denoted in FIG. 2 as “OPEN”).

The doorway 18 opens into a large, generally rectangular delacquering or coated scrap chamber 30 constructed of steel and various refractory materials. The delacquering chamber 30 has a vertical front wall 30A having dimensions of approximately 9 foot high by 24 foot wide, a vertical rear wall 30B opposite the front wall 30A having dimensions of approximately 16 foot high by 24 foot wide, a horizontal ceiling 30C having dimensions of approximately 31 foot deep by 24 foot wide, a first vertical sidewall 30D having dimensions of approximately 9 foot high by 31 foot wide, and a second vertical sidewall 30E opposite the sidewall 30D likewise having dimensions of approximately 9 foot high by 31 foot wide. The front wall 30A includes the doorway 18 and the gate 16.

The delacquering chamber 30 further has a delacquering zone 32 that is approximately twenty feet wide by ten feet tall, and extends approximately twenty feet into the chamber 30 from the doorway 18. The delacquering zone 32 has a relatively flat floor 34 that extends at a slight incline downward from the doorway 18 to a one-foot wide beveled lip 36 that crosses the far end of the floor 34 opposite the doorway 18. Scrap aluminum A is loaded through the doorway 18 onto the floor 34 for initial processing in the chamber 30. The lip 36 slopes downward from the floor 34 at an angle of approximately 45 degrees to a vertical wall 38 that forms the front end of a depressed, generally rectangular pool, known as a “creek bed” 40, at the end of the delacquering chamber 30. The creek bed 40 is approximately two feet deep, twenty feet long and ten feet wide. The creek bed 40 terminates at the vertical rear wall 30B.

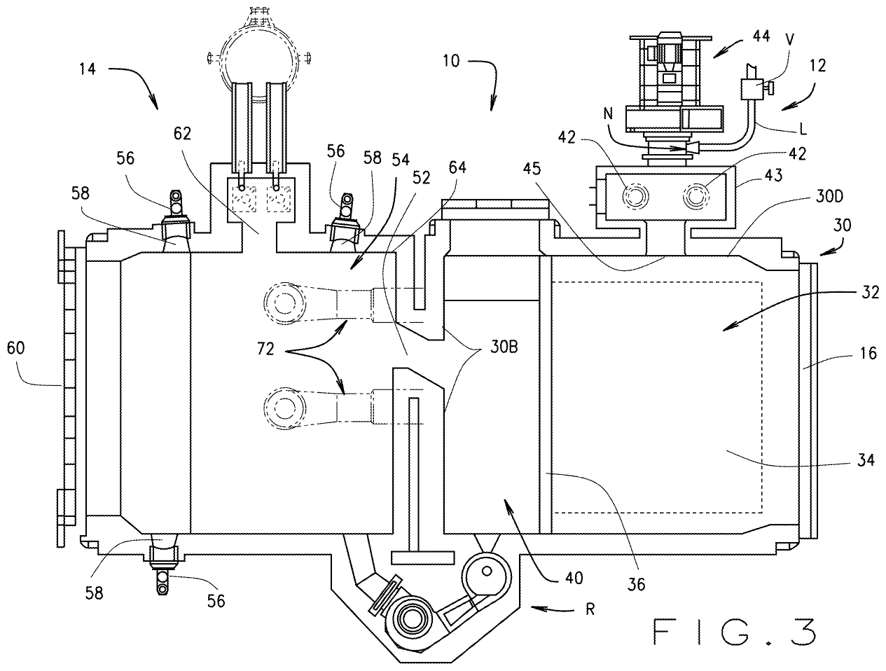

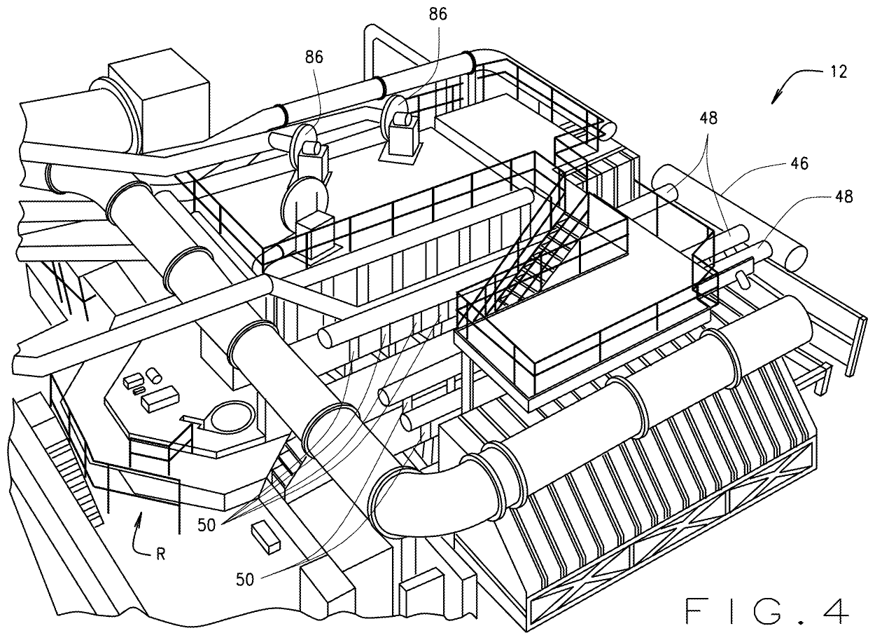

Referring to FIGS. 3 and 4, it can be seen that a set of gas burners 42, associated with a hot gas generator 43, and a recirculation burner fan 44, are positioned outside the delacquering chamber 30 adjacent the vertical sidewall 30D. The gas burners 42 are positioned on top of, and extend partially into, the hot gas generator 43, such that the heat generated by the gas burners 42 is directed downward into the hot gas generator 43. The recirculation fan 44 draws gases from the delacquering chamber 30 through a square opening 45 in the middle of the sidewall 30D, and into the hot gas generator 43, where they are heated to approximately 1000 degrees Fahrenheit. These gases are heated using gaseous fuel, such as natural gas, which is supplied to the burners 42, to ignite and burn the gaseous fuel and to simultaneously heat the gases drawn from the delacquering chamber 30 in the hot gas generator 43. The recirculation fan 44 then directs the hot exhaust gases exiting the hot gas generator 43 into a cylindrical steel duct manifold 46 positioned above the burners 42 and horizontally next to the top of the furnace 10 above the delacquering chamber 30 (see FIG. 4). The manifold 46 directs the hot exhaust gases from the burners 42 into three smaller cylindrical steel ducts 48 that extend in a parallel fashion over the top of the delacquering chamber 30 above the floor 34. A series of even smaller cylindrical steel ducts 50 extend from each of the ducts 48 downward into and through the top of the delacquering chamber 30, such that the hot exhaust gases are directed downward into the chamber 30 and onto the scrap aluminum A positioned on the floor 34 of the chamber 30.

As can be seen from FIG. 3, a diagonal channel 52 running through the wall 30B connects the creek bed 40 to a second chamber 54 behind the wall 30B. This second chamber 54, having dimensions of approximately twenty feet wide and twenty feet long, is known as the “melt chamber” or “heating chamber” where the scrap aluminum A is fully melted and forms a pool of molten metal. A set of various gas fueled burners 56 direct heated exhaust gases through their associated cylindrical refractoryducts 58 into the heating chamber 54 to melt the aluminum in the chamber 54. The burners 56 help elevate the temperature in the heating chamber 54 to over 2,000 degrees Fahrenheit.

A rear gate 60 provides access to the heating chamber 54 for various activities, such as for example repairs, maintenance, upgrades, and cleaning. An electric lift motor 122 and associated lift gears 124, are positioned above the rear door 60 atop the rear end 14 of the furnace 10. A set of heavy chains 126 attach at one end to the top of the door 60 and attach at the other end to the lift gears 124. The motor 122, lift gears 124 and chains 126 collectively form an opening system 128 for the door 60. The computer control system for the furnace 10 operatively communicates with the opening system 128 to controllably raise and lower the door 60 between its closed position (as depicted in FIG. 1 and denoted in FIG. 2 as “CLOSED”), in which the door 60 rests against and seals the rear doorway, and its open position in which the door 60 fully exposes the rear doorway (as depicted and denoted in FIG. 2 as “OPEN”).

A channel 62, positioned at the bottom of a sidewall 64 of the heating chamber 54 provides a path for molten aluminum to exit the heating chamber 54 for removal from the furnace 10.

Referring again to FIG. 2, an eductor vacuum hood 70 is positioned directly above and open to the creek bed 40 below. The hood 70 is approximately twenty feet wide, eight feet tall and ten feet deep. Two matching eductor systems 72 are integrated into the hood 70. More particularly, each of the eductor systems 72 has a circular gas suction port 74, a cylindrical refractory gas mixing chamber 76, a cylindrical motive gas tube 78, a cylindrical refractory gas discharge port 80, and a variable speed blower 86. The gas suction port 74, motive gas tube 78, and gas discharge port 80 all open into the gas mixing chamber 76 as shown. The motive gas tube 78 has a diameter that is substantially smaller than the diameter of the mixing chamber 76, such that a length of the motive gas tube 78 can be readily positioned inside of the mixing chamber 76. The motive gas tube 78 enters the topside of the mixing chamber 76 where it then turns 90 degrees in the center of the mixing chamber 76 to point downstream away from the gas suction port 74.

Each of the gas suction ports 74 extends through the rear sidewall of the hood 70 to provide a path for exhaust gases and VOC's collected in the hood 70 to be drawn into the eductor mixing chambers 76. A pair of cylindrical steel exhaust channels or ducts 82 connect their respective circular gas discharge ports 80 to the heating chamber 54 and enter the heating chamber 54 through complementary circular openings 84 in the ceiling of the heating chamber 54. The variable speed blowers 86, one for each of the eductors attached to the top of the hood 70, directs motive gases (from atmosphere or from an alternate source, such as for example a vacuum pump (not shown) connected to one or more furnace chambers, such as the melt chamber 54) into their respective motive gas tubes 78, and thereby into the eductors' gas mixing chambers 76, where the combine with gases from the exhaust hood 70 to form a motive gas mixture.

As can readily be appreciated, as the variable speed blowers 86 force motive gases through the motive gas tube 78, into the mixing chambers 76 and toward the gas discharge ports 80, a Venturi effect is created in the mixing chambers 76 that creates a vacuum that draws gases from the hood 70, through the gas suction ports 74, into the mixing chambers 76, and out through the gas discharge ports 80.

The variable speed blowers 86 in the eductors are operatively connected to the computer control system CCS for the furnace 10 that collects electronic data representative of gaseous conditions in each of the eductor systems 72. Program codes in the computer control system CCS utilize this electronic data to increase or decrease the speed of the blower 86 so as to control the flow of motive gases into the motive gas tubes 78, which thereby controls the Venturi effect in the mixing chambers 76, which in turn controls the vacuum draw in the inlet ports 74 to control the draw of exhaust gases and VOC's from the hood 70 through the eductor systems 72 and into the heating chamber 54.

As can be appreciated, Applicants' aluminum recycling system or furnace 10 utilizes a multi-step process. First, bulk loads or bails of coated aluminum scrap A are fed into the furnace's coated scrap hearth or delacquering chamber 30 through the full-width hearth doorway 18 when the door 16 is in its raised or “OPEN” position. The burners 42 heat the hot gases to approximately 1000 Deg. F and the recirculation blower 44 forces these hot gases down upon the pile of coated scrap aluminum A positioned on the floor 34 of the delacquering chamber 30. These hot gases are introduced into the delacquering chamber 30 above the coated scrap aluminum A. As the scrap aluminum A moves from the doorway 18 to the creek bed 40 across the floor 34, the organics and other non-metal particulates (i.e., the “VOC's”) begin to volatilize and are drawn into the vacuum hood 70 by the eductor systems 72, which are initially running at a minimum speed.

After the VOC's have been removed from the scrap aluminum A in the delacquering chamber 30, the scrap aluminum drops into the creek bed 40, where it joins a flow of molten aluminum recirculating from the heating/melt chamber 54. The molten aluminum in the creek bed 40 circulates into the heating chamber 54 through the channel 52 in the rear sidewall 30B of the chamber 30. The molten aluminum is heated in the heating chamber 54 by the heat generated by the burners 56 in combination with the heat provided from the eductor systems 72. A portion of the melted aluminum in the heating chamber 54 is allowed to exit the furnace 10 through the channel 62 for removal from the system 10, while another portion of the melted aluminum is returned to the creek bed 40 by a recirculating system R (see FIG. 3).

Depending upon the operating conditions in the delacquering chamber 30 of the furnace 10, the blowers 86 for each of the two eductor systems 72 can be ramped up by the computer control system CCS to higher running speeds in order to increase the flow of motive gases into the motive gas tubes 78, which thereby increases the Venturi effect in the mixing chambers 76, which in turn increases the vacuum draw in the inlet ports 74 to increase the draw of exhaust gases and VOC's from the hood 70 through the eductor systems 72 and into the heating chamber 54. The VOC's drawn into the eductor systems 72 mix with the motive gases introduced in the mixing chambers 76 by the blowers 86 through the motive gas tubes 78, and are ignited by pilot burners 89 located in the ducts 82 downstream from the discharge end of the eductors 72, i.e., proximate the circular openings 80 that open into the ceiling of the heating chamber 54. Each pilot burner 89 has a small gas line 89A that provide an uninterrupted flow of fuel to each pilot burner 89 to ensure it remains alight during operation of the furnace 10. The computer control system CCS also has a process control loop (not shown) that monitors the pilot burners 89 to ensure that they are functioning properly. The ignited gases and VOC's from the eductors 72 “fire down” through the openings 80 onto the molten aluminum/metal bath of the heating chamber 54.

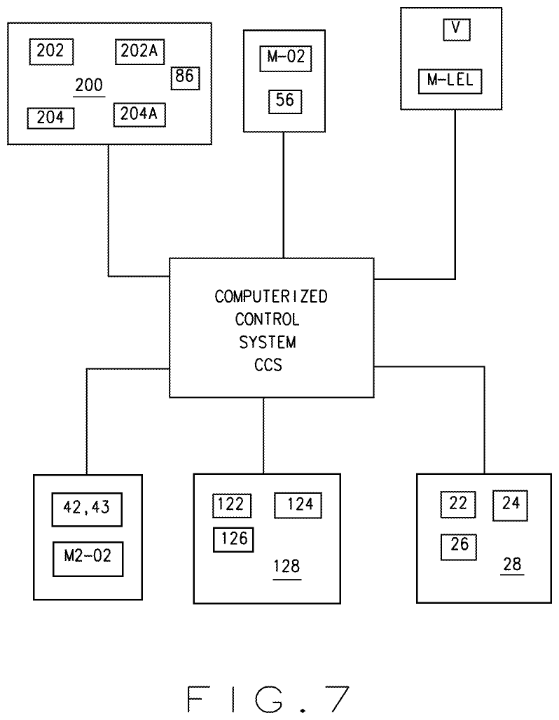

An Oxygen monitor M-O2 (see FIG. 7; not shown in FIGS. 1-6) positioned in the exhaust flue for the heating chamber 54 continually monitors Oxygen levels evacuating the chamber 54 and communicates its readings to the computer control system CCS. The CCS adjusts and controls the air/gas ratio of the heating chamber burners 56 to ensure the burning of any residual VOC's before such VOC's exit the chamber 54.

Further, another Oxygen monitor M2-O2 positioned in the hood 70 continually monitors Oxygen levels in the hood 70 over the creek bed 40, generates an electric signal indicative of the Oxygen level in the hood 70, and communicates that electronic signal to the computer control system CCS. This 4-20 mA electric signal reflects a range of 0% to 21% Oxygen. The Oxygen level in the delacquering chamber 30 will have a predetermined “low O2” set-point between 0-6% to prevent combustion from occurring in the delaquering chamber 30. The burner fuel-mix ratios for each of the burners 42 in the hot gas generator 43 are adjusted and controlled by the computer control system CCS based upon the Oxygen level measured in the hood 70 by the monitor M2-O2, so as to maintain a desired Oxygen level within the delacquering chamber 30.

Programmed limits will prevent the burners 42 from firing outside of acceptable Oxygen ratio limits.

Finally, a lower explosive limit (“LEL”) monitor M-LEL, located in the delacquering chamber 30, detects the explosive level of the atmosphere within the delacquering chamber 30, and communicates that LEL level to the computer control system CCS. In the event that the LEL reading exceeds a predetermined “safe” level, the computer control system CCS recognizes an alarm state in the furnace 10 and opens an electronically controlled gas shut-off valve V connected to a Nitrogen supply line attached to the furnace 10, so as to automatically inject Nitrogen gas into the delacquering chamber 30 to reduce the LEL level and minimize the risk of explosion in the chamber 30. The Nitrogen gas is injected through an inlet gas port N proximate the recirculation blower 44. This results in generally even distribution of Nitrogen gas throughout the entire delacquering chamber 30. Of course, the Nitrogen can be injected at nearly any position in the system so long as sufficient Nitrogen reaches the chamber 30 to rapidly compensate for an excessive LEL reading. Of course, other neutral gases or neutral gas mixtures can be used in place of Nitrogen. When such an event occurs, the furnace doors 16 and 60 will both be automatically locked by the computer control system CCS during such high LEL event, and will not be allowed to open until the LEL reading has been reduced to a safe level.

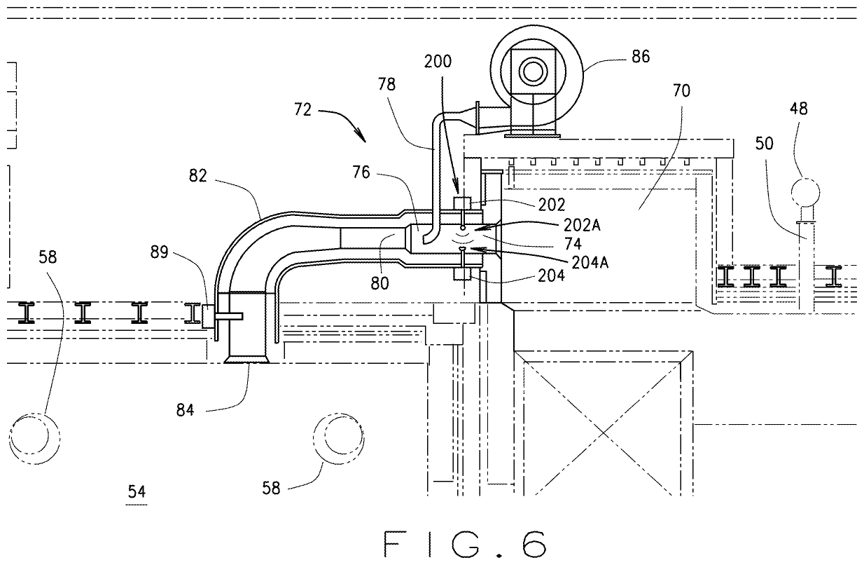

Referring again to FIG. 2, and more particularly to FIG. 6, the eductor systems 72 of the furnace 10 are each equipped with an infrared opacity sensor 200. Although the opacity sensor 200 can be configured to utilize sensors that sense light in various wavelength ranges, it is preferable to use a sensor calibrated to the infrared spectrum. First, infrared light is known to penetrate well through various smoky gases and is therefore more likely to provide a more accurate opacity density reading. Moreover, using an infrared opacity sensor provides the additional benefit of having the capability to detect flames or flashes upstream of the burners 89. This allows a control loop (not shown) in the computer control system CCS to inject Nitrogen into the furnace 10 and/or alter the furnace's burner ratios in response to any such detected condition in the eductors 72 when the O2 level is above its predetermined set point.

Each opacity sensor 200 has an electronic infrared generator or sending unit 202 and a corresponding electronic infrared receiver 204. Each sending unit 202 is positioned on the upper surface its corresponding duct 82 between the eductor's motive gas tube 78 and the vacuum hood 70. Each receiver 204 is positioned on the underside of the same duct 82 directly below the sending unit 202. The sending unit 202 has an infrared emitter 202A positioned inside the respective eductor's gas mixing chamber 76 along the top inner surface of the chamber 76. The receiver 204 has an infrared detector 204A positioned opposite the sending unit emitter 202A, inside the respective same mixing chamber 76 along the bottom inner surface of the chamber 76. The sending unit 202 controllably generates a beam of infrared light of a predetermined intensity at a predetermined wavelength, collection of differing wavelengths or range of wavelengths, from the emitter 202A downward into the mixing chamber 76 toward the detector 204A. The receiver 204 is calibrated to detect and measure infrared light of the same predetermined wavelength, collection of differing wavelengths or range of wavelengths, generated by the sending unit's emitter 202A.

The sending unit 202 and receiver 204 are functionally directed toward each other such that the infrared beam generated by the sending unit 202 crosses the interior of the mixing chamber 76, where the beam is received at a particular intensity from the sending unit 202. The intensity of the infrared beam will vary in relation to the amount of VOC's (i.e., VOC's) in the mixing chamber 76. That is, as the concentration of VOC's injected into the mixing chamber 76 from chamber 30 of the furnace 10 increases, the intensity of the infrared beam received by the receiver 204 will in correlation decrease by a calculable amount. Thus, the concentration of the VOC's (VOC's) in the mixing chamber 76 at any given time can be detected and measured by the opacity sensor 200.

The opacity sensor 200 houses a wireless transmitter that wirelessly communicates the intensity of the infrared light being generated by the sending unit 202 and the intensity of the infrared light being received by the receiver 204 to the system 10's computer control system CCS. The computer control system CCS is operatively connected to each of the variable speed blowers 86 such that the computer control system CCS is able to controllably increase or decrease the speed of the fans 86 in response to the opacity measurements from the opacity sensor 200 of the gases flowing through each of the mixing chambers 76. Of course, the opacity sensor 200 can be configured to make such communication through a wired interface with the system 10's computer control system CCS.

In practice, upon initial operation (i.e., before the furnace is generating VOC's) the variable speed blowers 86 operate at a minimum speed, and therefore generate relatively weak Venturi vacuums in the eductor systems 72. Once scrap metal (i.e., scrap aluminum A) is placed in the delacquering chamber 30, organics and particulates begin to volatilize in the heat of the chamber 30 and are drawn through the vacuum hood 70 and into the eductors 72 by the variable speed blowers 86, still running at a minimum speed. Volatiles that are not drawn into the eductors 72 are exhausted from the furnace 10. The opacity sensors 200 monitor the increasing concentration of these VOC's being run through the eductor systems 72. As the volatile concentration increases, the opacity across the throat of the eductor mixing chamber 76 diminishes. In response, the opacity receiver 204 increases the output (4-20MA) signal to the computer control system CCS for the furnace 10. The computer control system CCS, in turn, increases the speed of the motive gas blowers 86, which increases the volume of VOC's being forced through each eductor system 72. In this way, the furnace's computer control system CCS continuously monitors and regulates the flow of VOC's through the eductor systems 72.

In addition, the computer control system CCS automatically controls the raising and lowering of the doors 16 and 60, and utilizes an automated door opening and closing control loop (see FIG. 7) to ensure that front furnace door 16 and the rear furnace door 60 will both remain latched and not allowed to open as long as one or more of the opacity sensors 200 is detecting a concentration of VOC's being drawn into the eductors 72 above a predetermined safe level. Once the opacity sensors 200 sense that the concentration of VOC's has dropped below the predetermined safe concentration level, the computer control system CCS will release the furnace door latches and the furnace doors 16 and 60 will be allowed to be opened.

While we have described in the detailed description a configuration that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel opacity sensor 200 for a metal recycle furnace 10 of the present invention can be arranged in a number of other and related varieties of configurations without expanding beyond the scope of our invention as set forth in the claims.

For example, the sending unit 202 need not be positioned on the top portion of the mixing chamber 76, but may be positioned at any other orientation in the mixing chamber 76, so long as it can be functionally associated with the receiver 204, to perform as outlined hereinabove. Similarly, the receiver 204 need not be positioned at the bottom portion of the mixing chamber 76, but may be positioned at any other orientation in the mixing chamber 76, so long as it can be functionally associated with the sending unit 204, to perform as outlined hereinabove.

Moreover, each sensor 200 need not be located in the mixing chamber 76 of the eductor systems 72, but instead or additionally may be positioned in other areas of the eductor systems 72 or in the vents and ducts attached to the eductor systems 72, so long as the opacity sensor so positioned is capable of providing a measurement indicative of the VOC's concentration in a known or predetermined location in the eductor system 72. In addition, each eductor system 72 may be associated with more than one opacity sensor 200.

The opacity sensors 200 for the eductor systems 72 are not necessarily required to be installed in an aluminum delacquering and recycling furnace 10 as depicted in FIGS. 1-5, but may be installed or otherwise incorporated into a variety of configurations of metal recycling furnace and kiln systems. Further, the because the eductor system 72 is not constrained to the specific eductor configuration as shown in this disclosure, but may instead comprise various shapes, sizes and may be located at different positions on the furnace 10, the opacity sensors may be configured differently to accommodate such differing eductor systems.

In addition, the opacity sensors 200 need not be controlled by an overall or master computer control system CCS for the furnace 10. Rather, the opacity sensors can be part of a subsystem, can operate mechanically without a computer control system such as the system CCS, or can operate on an independent control loop—so long as the opacity sensor so controlled is able to monitor and properly regulate the flow of motive gases into an eductor system such as either off the eductors 72 as outlined herein. Further, such electronic and/or computerized control systems can be connected to the opacity sensors 200 by hardwire or wirelessly. Also, the variation in gas flow through the eductor system 72 in response to the opacity measurements from the opacity sensor 200 can be achieved through methods other than changing the speed of the variable speed blower 86. For example, a variable nipple can be attached to the end of the motive gas tube 78, or by way of further example a mass flow controller or a controllable gate valve can be placed in any one or more of the inlet port 74, the mixing chamber 76, the motive gas tube 78, or the gas discharge port 80. Any one or more of these types of controllers can be connected to and operated by the opacity sensor 200.

Additional variations or modifications to the configuration of the above-described novel exhaust hood overflow system for a metal recycle furnace 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of our invention.

What is claimed is:

1. An automatic variable speed eductor recirculation system for a metal recycling furnace, said furnace having a delacquering chamber and a heating chamber separated from said delacquering chamber, said delaquering chamber generating exhaust gases that include VOC's, said automatic variable speed eductor recirculation system comprising:
a. a recirculation duct, said recirculation duct providing a gaseous conduit from said delaquering chamber to said heating chamber;
b. a variable speed motive gas blower operatively associated with said recirculation duct;
c. an eductor positioned in said recirculation duct, said eductor having
i. a gas mixing chamber;
ii. a gas suction port, aid gas suction port having an upstream portion open to said delaquering chamber, said gas suction port having a downstream portion open to said gas mixing chamber, said gas suction port gases from said upstream portion through said downstream portion into said gas mixing chamber;
iii. a motive gas tube positioned downstream of said gas suction port, said motive gas tube having a first end that is connected to said blower and a second end that opens into said mixing chamber in an orientation directed away from said suction port; and
iv. a gas discharge port that exits in a downstream direction from said mixing chamber;
said blower forcing motive gases into and through said motive gas tube so as to inject and direct said motive gases from said blower into said mixing chamber in a direction away from said gas suction port, said injected motive gases creating a Venturi in said mixing chamber, said Venturi drawing gases from said furnace delacquering chamber through said gas suction port and directing said delacquering chamber gases through said mixing chamber, said motive gases and said delacquering chamber gases forming an eductor gas mixture in said mixing chamber, said exhaust port directing said eductor gas mixture toward said heating chamber of said furnace;
d. an opacity sensor, said opacity sensor being positioned in said recirculation duct proximate said eductor, said opacity sensor being oriented to measure the level of transparency of one or more of:
i. said motive gases;
ii. said delacquering chamber gases; and
iii. said eductor gas mixture;
said opacity sensor generating an electronic signal indicative of said transparency level being so measured; and
e. an electronic controller adapted to control the speed of said motive gas blower, said controller receiving said electronic signal from said opacity sensor and adjusting the speed of said motive gas blower in response to said signal.

2. The variable speed eductor recirculation system of claim 1,
wherein said opacity sensor comprises a light emitter and a light receiver directed toward but spaced apart from said emitter, said light emitter and said light receiver both being positioned in said recirculation duct proximate said eductor, said light emitter generating a light beam of a predetermined intensity and directing said light beam toward said light receiver, said light receiver receiving said light beam from said emitter and measuring the intensity of said light beam to determine said transparency level.

3. The variable speed eductor recirculation system of claim 2, wherein said light beam comprises infrared light having one of a predetermined wavelength; a collection of differing wavelengths; or a range of wavelengths.

4. The variable speed eductor recirculation system of claim 2, wherein said light beam comprises infrared light having a predetermined intensity.

5. The variable speed eductor recirculation system of claim 4, wherein said light receiver measures the intensity of said infrared light directed to said light receiver from said light emitter to determine said transparency level.

6. The variable speed eductor recirculation system of claim 1, wherein said opacity sensor comprises a wireless transmitter in wireless communication with said controller, said wireless transmitter wirelessly communicating said electronic signal to said controller.

7. The variable speed eductor recirculation system of claim 1, wherein said metal recycling furnace comprises a computer control system, said computer control system comprising said electronic controller.

8. The variable speed eductor recirculation system of claim 1, wherein said opacity sensor comprises a wireless transmitter and said electronic controller comprises a wireless receiver, said opacity sensor wirelessly communicating said electronic signal to said electronic controller.

9. The variable speed eductor recirculation system of claim 1, wherein said furnace further comprises an eductor vacuum hood, said hood being positioned above said delaquering chamber to collect exhaust gases and volatiles from said delaquering chamber, said upstream portion of said gas suction port being open to said hood instead of said delaquering chamber.

10. The variable speed eductor recirculation system of claim 1, wherein said opacity sensor emitter is positioned in one of said gas suction port, said mixing chamber, and said gas discharge tube.

11. An automatic gas flow control system for an eductor recirculation system in a metal recycling furnace, said furnace having a delacquering chamber and a heating chamber separated from said delacquering chamber, said eductor recirculation system having an eductor with a gas mixing chamber, a gas suction port, a motive gas inlet opening into said mixing chamber, and a gas discharge port exiting from said mixing chamber, said gas suction port drawing exhaust gases from said delacquering chamber and directing said gases into said mixing chamber, said motive gas inlet injecting and directing motive gases into said mixing chamber in a direction away from said gas suction port, said delacquering chamber exhaust gases mixing with said motive gases in said mixing chamber to form an eductor gas mixture, said exhaust port directing said eductor gas mixture toward said furnace heating chamber, said automatic gas flow control system comprising:
a. an electronic controller;
b. an optical sensor positioned in said eductor, said sensor measuring the concentration of volatiles in said eductor, generating an electronic signal indicative of said concentration of volatiles, and communicating said signal to said electronic controller; and
c. a variable speed blower, said blower being operatively associated with said electronic controller and with said motive gas inlet, said blower controllably injecting motive gases through said motive gas inlet into said eductor mixing chamber, said electronic controller adjusting said blower speed in response to electronic signal.

12. The eductor automatic gas flow control system of claim 11, further comprising a vacuum pump, said vacuum pump directing motive gases from said furnace into said blower.

13. The eductor automatic gas flow control system of claim 11, wherein said optical sensor comprises an opacity sensor, said opacity sensor measuring the level of transparency of one or more of:
a. said motive gases;
b. said delacquering chamber exhaust gases; and
c. said eductor gas mixture;
said opacity sensor generating an electronic signal indicative of said transparency level being so measured.

14. The eductor automatic gas flow control system of claim 13, wherein said opacity sensor comprises a light emitter and a light receiver directed toward but spaced apart from said emitter, said light emitter and said light receiver both being positioned in said recirculation duct proximate said eductor, said light emitter generating a light beam of a predetermined intensity and directing said light beam toward said light receiver, said light receiver receiving said light beam from said emitter and measuring the intensity of said light beam to determine said transparency level.

15. The eductor automatic gas flow control system of claim 14, wherein said light beam comprises infrared light having one of a predetermined wavelength; a collection of differing wavelengths; or a range of wavelengths.

16. The eductor automatic gas flow control system of claim 14, wherein said light beam comprises infrared light having a predetermined intensity.

17. The eductor automatic gas flow control system of claim 16, wherein said light receiver measures the intensity of said infrared light directed to said light receiver from said light emitter to determine said transparency level.

18. The eductor automatic gas flow control system of claim 13, wherein said opacity sensor comprises a wireless transmitter and said electronic controller comprises a wireless receiver, said opacity sensor wirelessly communicating said electronic signal to said electronic controller.

19. The variable speed eductor recirculation system of claim 11, wherein said furnace further comprises an eductor vacuum hood, said hood being positioned above said delaquering chamber to collect exhaust gases and volatiles from said delaquering chamber, said gas suction port drawing said delaquering chamber exhaust gases through said hood form said delaquering chamber.

20. The variable speed eductor recirculation system of claim 13, wherein said opacity sensor emitter is positioned in one of said gas suction port, said mixing chamber, and said gas discharge tube.
